(19) United States
(12) Patent Application Publication
(10) Pub. No.: US 2019/0126680 A1
(43) Pub. Date: May 2, 2019

(54) WHEEL LUG NUT TOOL

(71) Applicant: H. A. Eckhart & Associates, Inc., Lansing, MI (US)

(72) Inventor: Kyle Feldpausch, Lansing, MI (US)

(73) Assignee: H. A. Eckhart & Associates, Inc., Lansing, MI (US)

(21) Appl. No.: 15/801,384

(22) Filed: Nov. 2, 2017

(51) Int. Cl. B60B 29/00; B25B 13/48; B25B 17/00

(52) U.S. Cl. CPC B60B 29/003; B25B 17/00; B25B 13/48

(57) ABSTRACT

A hand operated tool for simultaneously threading a plurality of lug nuts onto corresponding studs of an axle includes a housing having a base onto which a plurality of lug gears, each carrying a lug socket, are rotatably mounted, and a circumferential side wall carrying an annular gear having teeth meshed with teeth of the lug gears. At least one lever arm extends radially away from an outer surface of the circumferential side wall to allow all required studs to be threaded onto a vehicle axle simultaneously.

### FIELD OF THE DISCLOSURE

This disclosure pertains to a device for starting, tightening, loosening or removing wheel lugs to facilitate removal of a wheel from a vehicle and securement of a wheel to a vehicle.

### BACKGROUND OF THE DISCLOSURE

Various devices or tools have been developed for concurrently loosening a plurality of lugs to remove a wheel from a vehicle or concurrently tightening a plurality of lugs to secure a wheel to a vehicle. However, these devices have incorporated power drivers and/or have comprised complicated mechanical arrangements, often including biasing components (e.g., springs) and/or planetary gear systems including a central or sun gear, resulting in a heavier and more expensive tool than is necessary or desired.

### SUMMARY OF THE DISCLOSURE

The disclosed tool enables simultaneous starting, tightening, loosening or removal of vehicle wheel lug nuts using a simple, lightweight design that does not employ powered (e.g., pneumatic, hydraulic or electric) drivers. The hand operated tool of this disclosure includes a frame, housing or carrier having a central axis, and includes a base and a circumferential side wall extending from the base. The circumferential side wall has an inner surface defining an annular gear. A plurality of lug gears are carrier by or mounted on the base for rotation relative to the base. Each of the lug gears has teeth engaging teeth of the annular gear, and are rotatable around an axis parallel to the central axis of the base. The rotational axes of the lug gears are parallel with the central axis of the housing, radially displaced from the central axis, and angularly displaced with respect to each other. Each of the plurality of lug gears carries a lug socket that is axially aligned with the axis of the lug gear. At least one lever arm extends radially outwardly from an outer surface of the circumferential side wall of the housing.

Also disclosed is an improved process for securing a wheel to a vehicle using the tool described herein. The process includes placing a lug nut in each of the sockets of the described tool, positioning a wheel on threaded studs projecting from an axle on which the wheel is to be secured, positioning the tool holding the lug nuts in alignment and contact with each of a corresponding threaded stud and rotating the tool relative to the wheel to simultaneously partially thread each of the lug nuts onto its corresponding threaded stud.

### BRIEF DESCRIPTION OF THE DRAWINGS

FIG. 1 is a perspective view of a tool for starting, loosening, tightening or removing lug nuts used for securing a wheel to a vehicle.

FIG. 2 is a top view of the tool shown in FIG. 1.

FIG. 3 is a side view of the tool shown in FIG. 1.

FIG. 4 is a bottom view of the tool shown in FIG. 1.

FIG. 5 is a cross-sectional view of the tool shown in FIG. 1, as seen along lines A-A of FIG. 1.

### DETAILED DESCRIPTION OF THE EMBODIMENTS

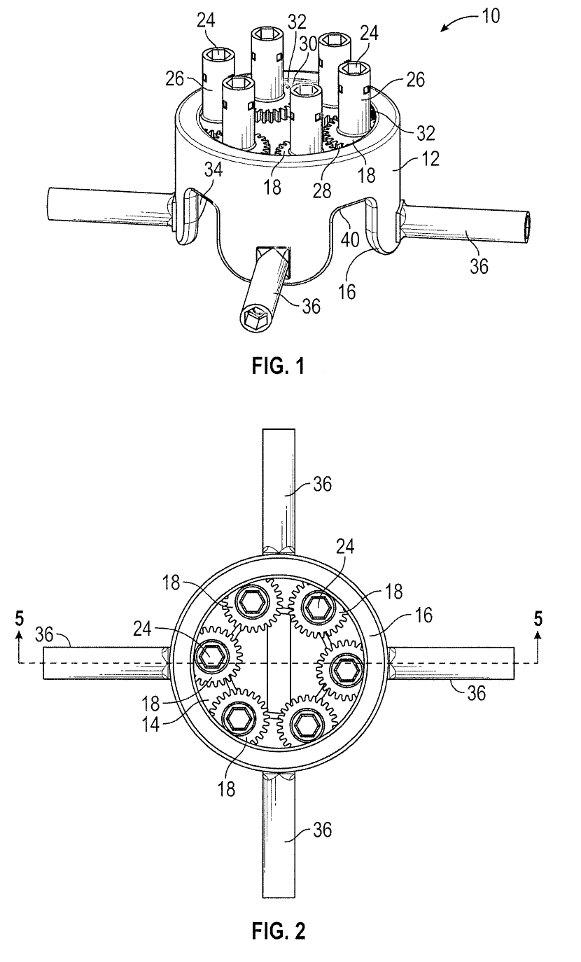

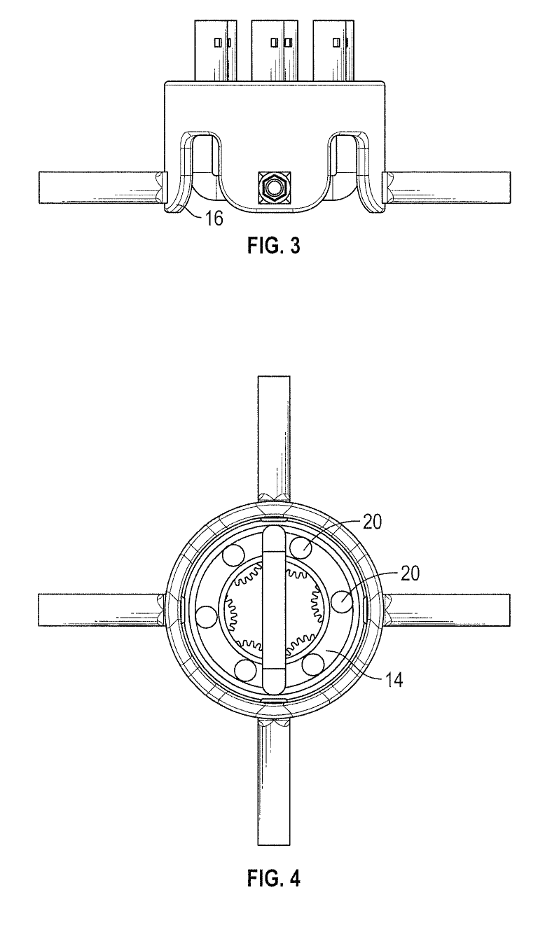

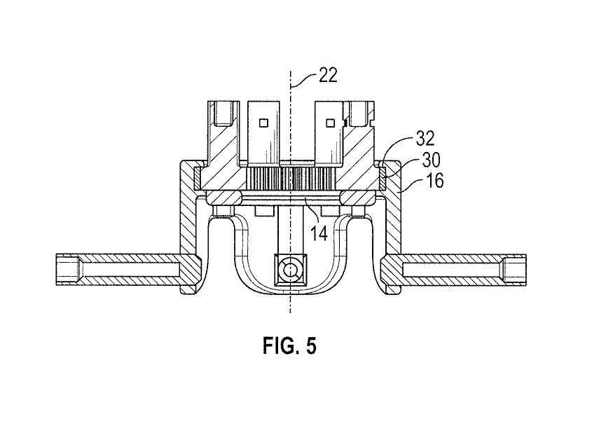

With reference to FIGS. 1-5, a hand operated tool 10 for simultaneously starting, loosening, tightening or removing lug nuts used to secure a wheel to a vehicle includes a housing 12 having a base 14 and a side wall 16 extending from the base.

Rotatably mounted on the base 14 are a plurality of lug gears 18, each lug gear corresponding with a threaded stud extending from an axle of a vehicle onto which a wheel is to be mounted. Lug gears 18 are rotatable about axially parallel axles 20, which are also parallel to a central axis 22 of tool 10. The rotational axes of the lug gears 18 are radially displaced from central axis 22 and angularly displaced with respect to each other (by 60 degrees in the illustrated embodiment).

Each lug gear 18 carries or defines a lug socket 24. In the illustrated embodiment, sockets 24 are defined in socket members 26 that are affixed to gears 18. However, as an alternative, gears 18 can be machined, cast or otherwise made to have an integral socket 24 for engaging a lug nut.

Lug gears 18 are each rotatably mounted on base 14 so that teeth 28 of gears 18 mesh with teeth 30 of annular gear 32. In the illustrated embodiment, annular gear 32 is a separately made component that is affixed to an inner surface 34 of side wall 16. However, as an alternative, teeth 30 of annular gear 32 can be integrally formed with housing 12 or machined into the inner surface 34 of side wall 16 of housing 12.

In order to reduce the need for awkward hand positioning and/or repositioning of tool 10 during use, a plurality of lever arms or handles 36 are provided. In the illustrated embodiment, four lever arms extend radially away from an outer surface of side wall 16. Each arm 36 is angularly spaced or displaced 90 degrees relative to an adjacent lever arm.

While tool 10 is useful for simultaneously starting threading of lug nuts onto threaded studs of a vehicle axle, tightening the nuts to secure a wheel to the vehicle, loosening lug nuts, and removing lug nuts, the tool is expected to be especially useful for rapidly starting the threading of lug nuts onto threaded studs of a vehicle during vehicle manufacturing and during wheel or tire replacement. High speed wheel installation during vehicle manufacturing typically involves manually starting to thread each lug nut individually and sequentially onto the corresponding threaded studs of the axle, and then using a power tool that simultaneously tightens all of the lug nuts to a prescribed torque to secure the wheel to the vehicle. The power tool is too large, heavy and unwieldly to be used for rapidly starting to thread the lug nuts onto the studs. However, tool 10 is relatively light in weight and can be easily positioned and manipulated to simultaneously start threading a plurality of lug nuts onto a vehicle axle, reducing the time and effort needed to begin treading of the lug nuts and prepare the combination for use of the power tool.

Housing 12 of tool 10 can be a generally cylindrical body provided with cut out sections 40 to help reduce weight of the tool.

Regarding the processes described herein, it should be understood that, although the steps of such processes have been described as occurring in a certain sequence, such processes could be practiced with the described steps performed in an order other than the exemplary order. It further should be understood that certain steps could be performed simultaneously, that other steps could be added, or that certain steps described herein could be omitted. In other words, the descriptions of processes herein are provided for the purpose of illustrating certain embodiments, and should in no way be construed to limit the claimed invention.

This description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In summary, it should be understood that the invention is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary.

What is claimed is:

1. A hand operated tool for simultaneously starting, loosening, tightening or removing multiple lug nuts used for securing a wheel to a vehicle, comprising:
a housing having a central axis and including a base and a circumferential side wall extending from the base, an inner surface of the circumferential side wall having an annular gear;
a plurality of lug gears rotatably mounted on the base of the housing and having teeth engaging teeth of the annular gear, the rotational axes of the lug gears being parallel with the central axis of the housing, radially displaced from the central axis, and angularly displaced with respect to each other;
a lug socket carried by, and axially aligned with the axis of, each of the plurality of lug gears; and
a lever arm extending radially away from an outer surface of the circumferential side wall.

2. The tool of claim 1, wherein each lug socket is defined in a socket member affixed to a corresponding lug gear.

3. The tool of claim 1, wherein the annular gear is a separately made component that is affixed to the housing.

4. The tool of claim 1, wherein a plurality of lever arms extend radially away from the circumferential side wall.

5. The tool of claim 1, wherein a total of four lever arms extend radially away from the circumferential side wall, and each lever arm is angularly separated by 90 degrees from an adjacent lever arm.

6. The tool of claim 1, wherein the housing comprises a generally cylindrical body having cut out sections to reduce weight.

7. The tool of claim 1, wherein the plurality of lug gears includes a total of six lug gears.

8. A process for securing a wheel to a vehicle, comprising:
placing a lug nut in each of the sockets of the tool of claim 1;
positioning a wheel on threaded studs projecting from an axle on which the wheel is to be secured;
positioning the tool holding the lug nuts with each of the lug nuts in alignment and contact with a corresponding threaded stud; and
rotating the tool relative to the wheel to simultaneously partially thread each of the lug nuts onto its corresponding threaded stud.
